(19) United States
(12) Patent Application Publication
(10) Pub. No.: US 2025/0149611 A1
(43) Pub. Date: May 8, 2025

(54) ELECTRODE/SEPARATOR STACK FOR A BATTERY CELL, AND METHOD FOR MANUFACTURING SUCH AN ELECTRODE/SEPARATOR STACK

(71) Applicant: Volkswagen Aktiengesellschaft, Wolfsburg (DE)

(72) Inventors: Kai STUEHM-VAN DOREN, Meine (DE); Jonas KLINGE, Wolfenbuettel (DE)

(73) Assignee: Volkswagen Aktiengesellschaft, Wolfsburg (DE)

(21) Appl. No.: 18/940,892

(22) Filed: Nov. 8, 2024

(30) Foreign Application Priority Data
Nov. 8, 2023 (DE) 10 2023 211 038.5

(51) Int. Cl. H01M 10/04; H01M 10/42; H01M 50/46

(52) U.S. Cl. CPC H01M 10/04; H01M 10/4235; H01M 50/461

(57) ABSTRACT

An electrode/separator stack for a battery cell, comprising at least an electrode, in particular a cathode, and a counter electrode, in particular an anode. The electrode is an integral part of a laminated composite, in which in each case a separator is laminated onto both sides of the electrode, and the two separators protrude beyond the electrode with an overhang on the edge side. An edge-side gap between the two separator overhangs is in particular completely filled with an edge protection film.

This nonprovisional application claims priority under 35 U.S.C. § 119(a) to German Patent Application No. 10 2023 211 038.5, which was filed in Germany on Nov. 8, 2023, and which is herein incorporated by reference.

### BACKGROUND OF THE INVENTION

### Field of the Invention

The invention relates to an electrode/separator stack for a battery cell, and to a method for manufacturing such an electrode/separator stack.

### Description of the Background Art

An electrode/separator stack may be manufactured by single-sheet stacking. In single-sheet stacking, the accuracy of placement of the electrode sheets and separator sheets in the electrode/separator stack is extremely important for the reliability and performance of the battery cell. Thus, during operation the electrochemical efficiency of the battery cell decreases more quickly with lower electrode coverage. In addition, incorrect placement of sheets may result in direct contact of the anode and cathode, possibly causing a short circuit and failure of the battery cells. To improve complete coverage of the anode and cathode despite inaccuracies in placement, for example the dimensions of the anode in the electrode/separator stack may be circumferentially larger than the cathode by an amount (1.5 mm, for example), and the dimensions of the separator may be larger than those of the anode.

The above-mentioned single-sheet stacking is carried out using handling units, which are complicated in terms of manufacturing technology. These handling units obtain their coordinates based on image processing, in which the position of each placed electrode/separator sheet is optically detected and evaluated after placement of each sheet in order to determine the placement accuracy.

During such an optical detection of the placement accuracy, position correction of the already placed electrode/separator sheets is not provided after the stacking process, so that, even though the placement error is recognized, it can no longer be eliminated afterwards. In addition, the stack manufacture carried out using image processing is metrologically complicated, and may result in position deviations of the single sheets stacked in the electrode/separator stack, depending on the system.

A battery cell that is known from US 2022/0148821 A1 includes an internal element that has a first main surface, a second main surface, a first side surface, a second side surface, a first end surface, and a second end surface. Also provided are a first internal electrode that extends to the first end surface, a second electrode that extends to the second end surface, a separator layer situated between the first and second electrodes, and an electrolytic solution. Moreover, the first electrode is situated at the first end surface, and the second electrode is situated at the second end surface. The first electrode, the second electrode, and the separator layer are combined to form a one-piece composite.

An electrode stack that is known from DE 10 2016 217 397 A1 is provided with an electrically insulating coating on at least one sheet edge side. The coating is applied from the liquid phase, and extends over the entire height of the electrode stack.

A manufacturing method and a manufacturing device for a battery having high battery power are known from JP 5375263 B2, in which a plurality of laminates made up of an electrode and a separator are formed.

### SUMMARY OF THE INVENTION

It is therefore an object of the invention to provide an electrode/separator stack and a method for manufacturing such an electrode/separator stack, in which the stacking operation is simpler than the prior art in terms of manufacturing technology, and which may be carried out with greater accuracy of placement.

The invention proceeds from an electrode/separator stack for a battery cell that is made up at least of an electrode, in particular a cathode, and a counter electrode, in particular an anode. The electrode is an integral part of a laminated composite, in which a separator is laminated onto both sides of the electrode. The two separators protrude beyond the electrode with an overhang on the edge side. According to the characterizing part of claim 1, an edge-side gap between the two separator overhangs is preferably completely filled with an edge protection film. The edge protection film, viewed in the thickness direction of the laminated composite, may have the same material thickness as the electrode. By means of the edge protection film, the corners and edges of the electrode may thus be protected from external mechanical stresses. During an alignment process that is carried out on the completed electrode/separator stack, the edge protection film may provide a dimensionally stable stop surface that enables damage-free transverse displacement of the electrode in the electrode/separator stack. In addition, the edge protection film acts as electrical insulation, which helps to increase the electrical safety of the battery cell.

The electrode/separator stack according to the invention may be manufactured in the manner of a single-sheet stack, in which the laminated composite and the counter electrode are stacked on top of one another as single sheets.

In an example, each of the separators may have an adhesion layer via which the separators are laminatable onto the electrode in a lamination process, in particular with formation of the laminated composite. In this way, the two separators and the electrode situated in between are already joined to form a one-piece structural unit before the stacking process is carried out, thus increasing the stacking accuracy in the electrode/separator stack, in particular compared to an electrode/separator stack in which the electrodes are stacked as single sheets.

The electrode and/or the counter electrode can be made of a substrate film. This substrate film can be coated on one or both sides with an electrode active material. The active material includes a binder, in particular a polymer binder, namely, preferably PVDF. To avoid unfavorable material pairing between the active material and the edge protection film and possibly the adhesion layer, the active material binder as well as the edge protection film and possibly also the adhesion layer are made of the same material. That is, both the adhesion layer and the edge protection film have the same material composition as the active material binder. This ensures resistance of the edge protection film with respect to the electrolyte. In addition, this ensures that the material pairing between the edge protection film and the active material binder is electrochemically stable or resistant.

The laminated composite, made up of the two separators and the electrode situated in between, may be provided as a flat, rectangular cutout. At one of its cutout sides (referred to below as the arrester tab side), the substrate film of the electrode may be laterally extended to the outside, beyond the separator edges, via an arrester tab. The edge-side gap filled with the edge protection film may extend continuously, at least along the cutout side facing away from the arrester tab side and along the cutout sides of the laminated composite, transversely with respect to the arrester tab side. No edge protection film is provided at the arrester tab side itself so that the arrester tab may be led out from the composite. This avoids thickening (due to the edge protection film) at the level of the arrester tab, which would be noticeable later. It is therefore advantageous for the edge protection film to be present at only three of the four total cutout sides, so that thickening cannot occur.

To allow complete coverage of the electrode (i.e., cathode) and the counter electrode (i.e., anode) despite placement inaccuracies, the counter electrode may preferably be circumferentially larger than the electrode by an amount (1 to 3 mm, for example). The counter electrode and the separators may preferably be manufactured as congruent sheet cutouts. That is, the counter electrode, except for its arrester tab, is dimensioned with the same surface area and contour as the separator, so that the corners and edges of the counter electrode may be brought into flush alignment with the corners and edges of the separators in the stacking direction.

A method for manufacturing the electrode/separator stack may be divided into a stacking process and a subsequent alignment process. In the stacking process, the laminated composite, made up of separators and an electrode, and the counter electrode are stacked on top of one another in the manner of a single-sheet stack. In the subsequent alignment process, the laminated composite and the counter electrode may be brought into flush alignment with one another in the stacking direction. Due to providing the edge protection film according to the invention, the laminated composite has a dimensionally stable structure, so that damage-free position correction of the laminated composite transverse to the stacking direction may be carried out. Such a dimensionally stable laminated composite also provides the neighboring counter electrode with a stable counter-support or a stable support base, so that position correction of the counter electrode may be carried out in a damage-free manner. At least one transverse stop, in particular a slider, may preferably be used in the alignment process. By use of the transverse stop, position correction of a stack component whose position is shifted transversely with respect to the stacking direction, i.e., the laminated composite or the counter electrode, may be carried out, i.e., may be put in flush alignment with the other stack components.

The edge protection film may be applied to the laminated composite in any suitable manner. As an example, the edge protection film may be applied to the laminated composite in a coating process in which a viscous starting component of the edge protection film is applied directly into the edge-side gap of the laminated composite. In an advantageous alternative variant, the edge protection film may also be introduced as a separate component, i.e., as a material having a solid phase (for example, film, adhesive film, etc.)

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1, 2a to 2c, 3a to 3c, 4 and 5 each show different views illustrating a structure and a manufacture of an electrode/separator stack according to an example of the invention.

### DETAILED DESCRIPTION

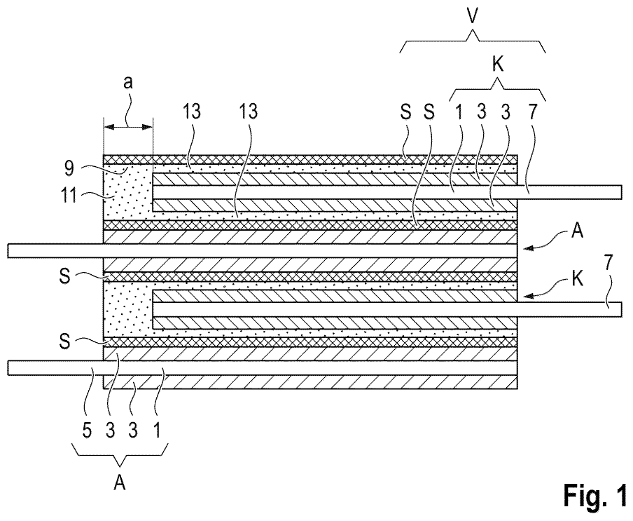

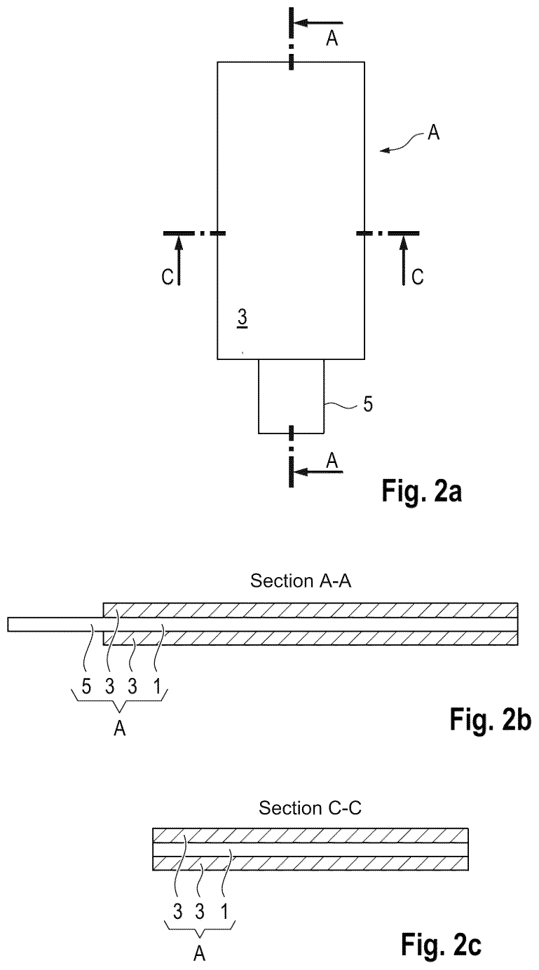

FIG. 1 shows a completed electrode/separator stack for a battery cell. This electrode/separator stack, from bottom to top in the stacking direction, includes an anode A, a cathode K, and a further anode A and a cathode K, each with separators S situated in between. The anode A by itself is indicated in FIGS. 2a through 2c. Accordingly, the anode A is a rectangular sheet cutout made of a substrate film 1. This substrate film is coated on both sides with active material 3. The substrate film 1 is extended outwardly with an anode arrester tab 5 at an oblong side.

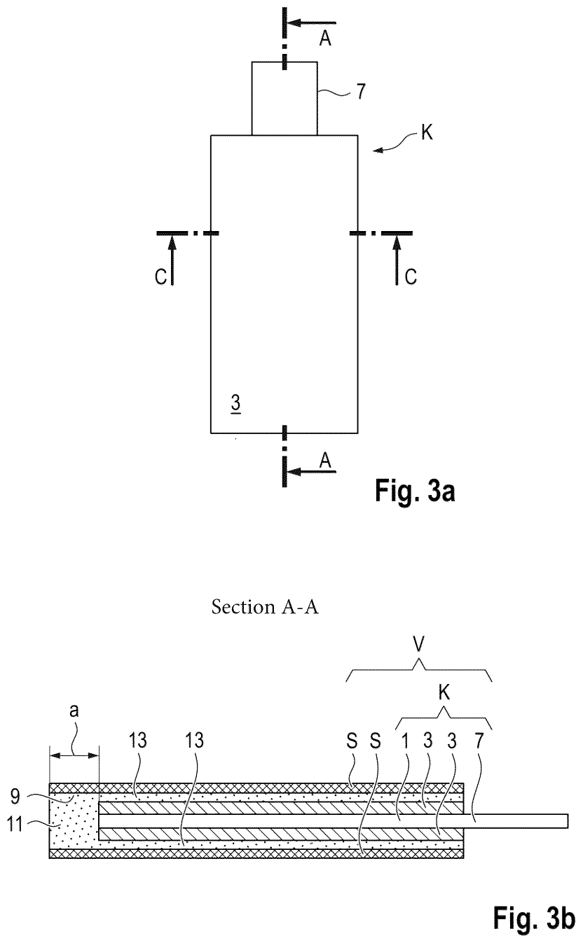

According to FIGS. 3a through 3c, the cathode K is likewise a rectangular sheet cutout made of a substrate film 1 which is coated on both sides with active material 3. The substrate film 1 of the cathode K is extended with a cathode arrester tab 7 at an oblong side. In contrast to the anode A, the cathode K according to FIGS. 3a through 3c is not provided as a single sheet prior to carrying out a stacking process. Rather, the cathode K together with the separators S is an integral part of a laminated composite V in which separators S have been laminated onto both sides of the cathode K under pressure and heat.

In the completed electrode/separator stack (FIG. 1), all anode arrester tabs 5 protrude from the left stack side, while all cathode arrester tabs 7 protrude from the right stack side.

As is further apparent from FIG. 1, the anode A is circumferentially larger than the cathode K by a dimension a (1 to 3 mm, for example). In this way, coverage of the anode A and the cathode K may be ensured despite placement inaccuracies. In addition, the separators S and the anode A are implemented as congruent sheet cutouts; i.e., except for the anode arrester tab 5 the separators S and the anode A have the same surface areas and contours, so that in the electrode/separator stack (FIG. 1) the corners and the edges of the anodes A are in flush alignment with the corners and edges of the separators S in the stacking direction.

In the laminated composite V, the two separators S protrude beyond the cathode K with an overhang which is identical to the dimension a. An edge-side gap 9 is thus formed which is delimited by the separator overhangs a and the cathode K. The edge-side gap 9 is completely filled with an edge protection film 11. This edge protection film, viewed in the thickness direction of the laminated composite V, has the same material thickness as the cathode K. The two separators S are each designed with an adhesion layer 13, via which the separators S are laminated onto the cathode K in a lamination process under pressure and heat, resulting in the laminated composite V.

The edge protection film 11 provides mechanical protection of the corners and edges of the laminated composite V. In addition, the edge protection 11 acts as an electrical insulator which prevents direct contact between the anode A and the cathode K. Furthermore, the edge protection film 11 increases the dimensional stability of the laminated composite V at its corners and edges.

The edge protection film 11 is made of a polymer material. To avoid unfavorable material pairing between the active material binder, i.e., PVDF, and the edge protection film 11, the edge protection film 11 is also made of PVDF. This also ensures chemical resistance against the electrolyte in the battery cell. It is emphasized that the invention is not limited to an edge protection film 11 made of PVDF; rather, the edge protection film 11 may also be made of other suitable materials instead of PVDF.

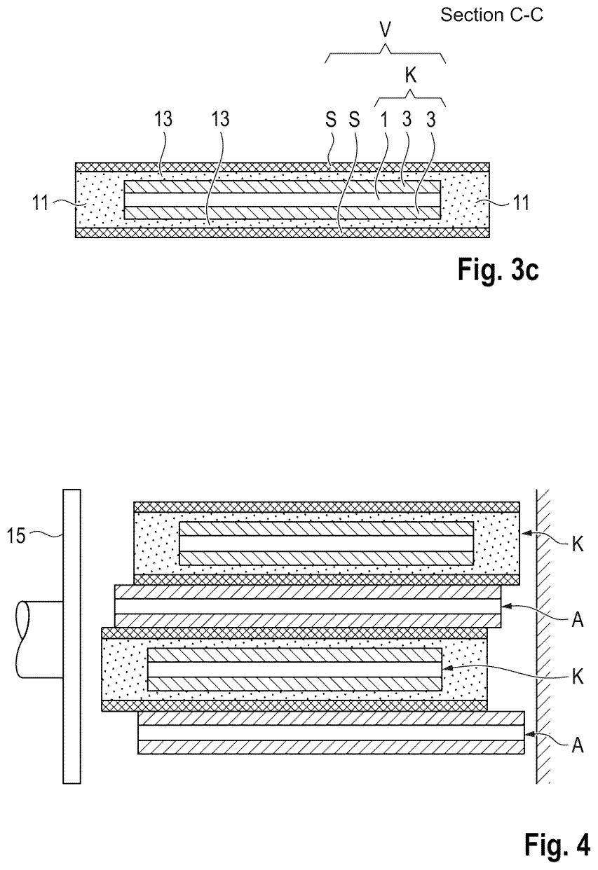

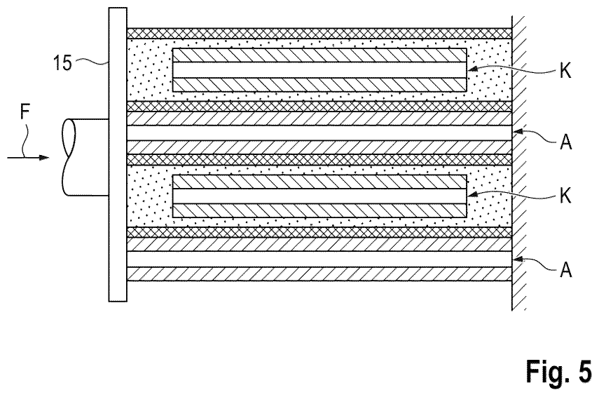

The electrode/separator stack (FIG. 1) is manufactured in a stacking process and a subsequent alignment process (FIGS. 4 and 5). In the stacking process, the laminated composite V and the anode A are stacked in alternation on top of one another. Position correction subsequently takes place in the alignment process (FIGS. 4 and 5), in which the stack components, i.e., the laminated composite V and the anode A, may be brought into flush alignment with the other stack components, using a slider 15. It is emphasized that the invention is not limited to use of the slider 15 shown in the figures. Rather, the alignment may also take place via the force of gravity, and may thus be carried out in a self-centering manner. Alternatively, the alignment function may be achieved by use of a vibratory plate having fixed stops.

The alignment force F which acts on the electrode/separator stack, transversely with respect to the stacking direction, by use of the slider 15 may optionally also be acted on by the force of gravity.

By use of the invention, flawless stacking accuracy may be achieved, independently of image processing and a handling device. The stacking accuracy is increased to a high degree by means of inexpensive technology (i.e., a slider 15). In addition, the stacking accuracy is adjustable after the stacking process, i.e., in the alignment process.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electrode/separator stack for a battery cell, comprising:
at least one electrode, in particular a cathode;
at least one counter electrode, in particular an anode, the electrode being an integral part of a laminated composite, in which in each case a separator is laminated onto both sides of the electrode, and the two separators protruding beyond the electrode with an overhang on an edge side; and
an edge-side gap formed between the two separator overhangs is completely filled with an edge protection film, the edge protection film and the electrode having a same material thickness viewed in a thickness direction of the laminated composite.

2. The electrode/separator stack according to claim 1, wherein each of the separators has an adhesion layer via which the separators are laminatable onto the electrode in a lamination process with formation of the laminated composite.

3. The electrode/separator stack according to claim 1, wherein the electrode and/or the counter electrode are made of a substrate film which is coated on one or both sides with an active material, and wherein the active material includes a binder, a polymer binder, PVDF, and/or an active material binder, and wherein the edge protection film and/or the adhesion layer are made of the same material.

4. The electrode/separator stack according to claim 1, wherein the laminated composite is a rectangular, flat cutout, and at one of its cutout sides or at an arrester tab side, the substrate film of the electrode is laterally extended to the outside, beyond the separator edges, via an arrester tab, and wherein the edge-side gap filled with the edge protection film extends continuously, at least along the cutout side facing away from the arrester tab side and along the two sides of the laminated composite transversely with respect to the arrester tab side.

5. The electrode/separator stack according to claim 4, wherein the edge-side gap filled with the edge protection film, except for the arrester tab side, extends circumferentially along all cutout sides of the laminated composite.

6. The electrode/separator stack according to claim 1, wherein the separators and the counter electrode are congruent sheet cutouts or have the same surface area and contour, except for the arrester tab of the counter electrode so that corners and edges of the counter electrode are brought into flush alignment with the corners and edges of the separators in a stacking direction.

7. The electrode/separator stack according to claim 1, wherein a method for manufacturing the electrode/separator stack comprises a stacking process in which the laminated composite and the counter electrode are loosely stackable on top of one another in the stacking direction, and an alignment process, in which the laminated composite and the counter electrode are brought into flush alignment with one another in the stacking direction.

8. The electrode/separator stack according to claim 7, wherein in the alignment process, at least one transverse stop or a slider is used, via which a stack component or the laminated composite or the counter electrode, which is shifted transversely with respect to the stacking direction, is brought into flush alignment with the other stack components.

9. The electrode/separator stack according to claim 1, wherein the edge protection film is appliable to the laminated composite in a coating process, in which a viscous starting component of the edge protection film is appliable directly into the edge-side gap of the laminated composite.

10. A method for manufacturing the electrode/separator stack according to claim 1 for a battery cell comprising at least an electrode, in particular a cathode, and a counter electrode, in particular an anode, the electrode being an integral part of a laminated composite, the method comprising:
laminating a separator onto both sides of the electrode, the two separators protruding beyond the electrode with an overhang on the edge side; and
completely filling an edge-side gap between the two separator overhangs with an edge protection film such that the edge protection film and the electrode have a same material thickness viewed in the thickness direction of the laminated composite.
